(19) United States
(12) Patent Application Publication
(10) Pub. No.: US 2004/0190896 A1
(43) Pub. Date: Sep. 30, 2004

(54) Multi-directional optical branching apparatus

(75) Inventor: Takafumi Terahara, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/789,998

(22) Filed: Mar. 2, 2004

(30) Foreign Application Priority Data
Mar. 28, 2003 (JP) 2003-090805

(51) Int. Cl. G02F 1/00

(52) U.S. Cl. 398/5

(57) ABSTRACT

An object of the invention is to realize a low cost, low loss multi-directional optical branching apparatus with a simple configuration, capable of outputting WDM signal lights of uniform power in three or more directions. To this end, the multi-directional optical branching apparatus of the invention is provided with 2×N optical multiplexing/demultiplexing devices for N (N≧3) optical transmission paths, and a branch port connecting section that connects in one to one between the respective branch ports. The apparatus demultiplexes respectively the WDM signal light input from an input side optical path of each of the optical transmission paths into N−1 wavelength groups, and then multiplexes each of the demultiplexed groups with optical signals of different wavelength groups from other directions, to output to an output side optical path of a predetermined optical transmission path.

### BACKGROUND OF THE INVENTION

1. Field of the Invention

The present invention relates to a multi-directional optical branching apparatus used in a wavelength division multiplexing (WDM) optical transmission system for multiplexing and transmitting optical signals with one or more different wavelengths within the same optical fiber, to realize large capacity communication.

2. Related Art

In a WDM optical transmission system, as shown in FIG. 17, there is a case where an optical branching apparatus for branching a WDM signal light in three directions according to wavelength, is used in an optical branching node, when the WDM signal light is transmitted/received between respective terminals at a plurality of sites (here, sites A to C). This optical branching apparatus is sometimes called an optical branch unit or a hub node. As a method of branching the WDM signal light in the above optical branching apparatus, there is, for example, a method in which an incident WDM signal light is separated for each single wave, and after the optical signal of each wavelength is converted once into an electrical signal, the electrical signal is reconverted into the optical signal, to be sent to a predetermined optical fiber. However, in such a branching method, there is a disadvantage in that the cost of the optical branching apparatus is high, due to the necessity of performing the optic-electric conversion for each of the optical signals of the respective wavelengths contained in the WDM signal light.

As a conventional technology for solving the aforementioned disadvantage of the optical branching apparatus, a three-directional optical branching apparatus as shown in FIG. 18 has been proposed (refer to Japanese Unexamined Patent Publication No. 9-116490). In this three-directional optical branching apparatus 100, by using WDM couplers 101A, 101B and 101C each having four input/output ports, WDM signal light which has been input from each of transmission optical fiber pairs F₁, F₂ and F₃ corresponding to three directions is branched according to wavelength, to be output from the transmission optical fiber pairs of other directions. As a result, a low cost, low loss optical branching apparatus with a simple configuration combining three WDM couplers is realized.

However, the above conventional optical branching apparatus as shown in FIG. 18 has the following problems.

(1) It cannot perform the branching of WDM signal light in four or more directions.

(2) Since there exist an optical path passing through the WDM coupler twice, and an optical path passing through the WDM coupler only once, the non-uniformity of power occurs in the WDM signal light obtained by multiplexing the optical signals which have been propagated through these optical paths. Also, from structural limitations, even if a power adjustment device such as, for example a variable optical attenuator or an optical amplifier, is used, it is still difficult to correct the above non-uniformity of power.

(3) In a WDM coupler which demultiplexes WDM signal light between a long wavelength region and a short wavelength region, it is generally difficult to realize a sharp optical filter characteristic (light passing characteristics with respect to a long wavelength side and a short wavelength side), and therefore, the usable wavelength band of the WDM signal light becomes limited. Specifically, as shown for example in the optical filter characteristic of FIG. 19, since an optical signal cannot be arranged in a wavelength region in which the respective light passing characteristics of the long wavelength side and the short wavelength side transit, it is necessary to ensure constant intervals between the long wavelength region and the short wavelength region, resulting in that the usable wavelength band becomes limited.

### SUMMARY OF THE INVENTION

The present invention has been accomplished in view of the aforementioned problems (1) to (3), with an object of realizing a low cost, low loss multi-directional optical branching apparatus with a simple configuration, which is capable of outputting WDM signal light of uniform power in three or more directions.

In order to achieve the above object, as shown in FIG. 1 for example, a multi-directional optical branching apparatus according to the present invention, connected to N (N≧3) optical transmission paths F₁ to F_{N} each having a pair of optical paths corresponding to an up-link and a down-link which transmit WDM signal lights in mutually different directions, for demultiplexing a WDM signal light input from an input side optical path IN of each of optical transmission paths F₁ to F_{N} into N−1 wavelength groups G₁ to G_{N-1}, and then multiplexing each demultiplexed group with optical signals of different wavelength groups from other directions to output the multiplexed signal light to each output side optical path OUT of a predetermined optical transmission path, comprises 2×N optical multiplexing/demultiplexing devices 1_{1A}, 1_{1B}, 1_{2A}, 1_{2B}, . . . 1_{NA}, 1_{NB} and a branch port connecting section 2. Each of the optical multiplexing/demultiplexing devices 1_{1A}, 1_{1B}, 1_{2A}, 1_{2B}, . . . 1_{NA}, 1_{NB} includes one common port P_{c} which is connected in one to one with any one of the input side optical paths IN or the output side optical paths OUT of the N optical transmission paths F₁ to F_{N}, and N−1 branch ports P₁ to P_{N-1}, and has a light passing characteristic capable of demultiplexing a WDM signal light input to the common port P_{c} into the respective wavelength groups G₁ to G_{N-1}, to output from the corresponding branch ports P₁ to P_{N-1}, and also multiplexing the signal lights which belong to the respective wavelength groups G₁ to G_{N-1}, input to the branch ports P₁ to P_{N-1}, to output from the common port P_{c}. Also, the branch port connecting section 2 connects in one to one between the respective branch ports of 2×N optical multiplexing/demultiplexing devices 1_{1A}, 1_{1B} to 1_{NA}, 1_{NB}, in accordance with previously set connection rules.

Furthermore, it is preferable that the above branch port connecting section 2 connects in one to one between the respective branch ports of the 2×N optical multiplexing/demultiplexing devices, so that following first through third connection rules are satisfied simultaneously.

First connection rule: Branch ports of an optical multiplexing/demultiplexing device where a common port thereof is connected with an input side optical path of one optical transmission path among N optical transmission paths, are connected in one to one with branch ports of an optical multiplexing/demultiplexing device where a common port thereof is connected with an output side optical path of another optical transmission path.

Second connection rule: Branch ports corresponding to the same wavelength group are connected with each other.

Third connection rule: For all of combinations where any two are selected from among N optical transmission paths, between respective branch ports are connected so that the up-link path and the down-link path are respectively linked.

In the multi-directional optical branching device of such a configuration, the WDM signal lights input from the input side optical paths IN of the respective optical transmission paths F₁ to F_{N} corresponding to N directions, to the common ports P_{C} of the respective optical multiplexing/demultiplexing devices 1_{1A}, 1_{2A}, . . . 1_{NA} are respectively demultiplexed for each of the wavelength groups G₁ to G_{N-1}, to be output to the corresponding branch ports P₁ to P_{N-1}. Optical signals which belong to the respective wavelength groups G₁ to G_{N-1}, output to the branch ports P₁ to P_{N-1} of the respective optical multiplexing/demultiplexing devices 1_{1A}, 1_{2A}, . . . 1_{NA}, are sent to the respective branch ports P₁ to P_{N-1} of the optical multiplexing/demultiplexing devices 1_{1B}, 1_{2B}, . . 1_{NB} which are connected in one to one by the branch port connecting section 2, to be multiplexed, and then, output from the common ports P_{C} of the optical multiplexing/demultiplexing devices 1_{1B}, 1_{2B}, . . . 1_{NB}, to the output side optical paths OUT of the respective optical transmission paths F₁ to F_{N}.

As a result, since the optical signals can be collectively demultiplexed and multiplexed for each of the wavelength groups G₁ to G_{N-1}, a low cost and low loss optical branching apparatus can be realized with a simple configuration, and also since the optical signals propagated within the apparatus always pass through two optical multiplexing/demultiplexing devices, it is also possible to easily achieve power balance of the WDM signal lights output to the output side optical paths OUT of the respective optical transmission paths F₁ to F_{N}.

Other objects, features and advantages of the present invention will become clear from the following description of the embodiments, in conjunction with the appended drawings.

### BRIEF DESCRIPTION OF THE DRAWINGS

FIG. 1 is a diagram showing a configuration of a multi-directional optical branching apparatus according to the present invention.

FIG. 2 is a block diagram showing a three-directional optical branching apparatus according to a first embodiment of the present invention.

FIG. 3 is a diagram for explaining a function of an optical multiplexing/demultiplexing device using a WDM coupler in the above first embodiment.

FIG. 4 is a diagram showing an example of a light passing characteristic of the optical multiplexing/demultiplexing device using the WDM coupler in the above first embodiment.

FIG. 5 is a diagram for explaining a function of an optical multiplexing/demultiplexing device using an optical interleaver in the above first embodiment.

FIG. 6 is a diagram showing an example of a light passing characteristic of the optical multiplexing/demultiplexing device using the optical interleaver in the above first embodiment.

FIG. 7 is a block diagram showing a four-directional optical branching apparatus according to a second embodiment of the present invention.

FIG. 8 is a diagram for explaining a function of an optical multiplexing/demultiplexing device using an optical interleaver in the above second embodiment.

FIG. 9 is a diagram showing an example of a light passing characteristic of a former stage interleaver consisting the optical multiplexing/demultiplexing device in the above second embodiment.

FIG. 10 is a diagram showing an example of a light passing characteristic of a latter stage interleaver consisting the optical multiplexing/demultiplexing device in the above second embodiment.

FIG. 11 is a diagram showing another configuration example related to the above second embodiment.

FIG. 12 is a diagram for explaining a function of the optical multiplexing/demultiplexing device using an optical interleaver in the configuration example of FIG. 11.

FIG. 13 is a diagram showing an example of a light passing characteristic of a former stage interleaver consisting the optical multiplexing/demultiplexing device in the configuration example of FIG. 11.

FIG. 14 is a block diagram showing a three-directional optical branching apparatus according to a third embodiment of the present invention.

FIG. 15 is a block diagram showing a modified example related to the above third embodiment.

FIG. 16 is a block diagram showing a three-directional branching apparatus according to a fourth embodiment of the present invention.

FIG. 17 is a diagram showing a schematic configuration of a typical WDM optical transmission system having an optical branching node.

FIG. 18 is a diagram showing a configuration of a conventional three-directional optical branching apparatus.

FIG. 19 is a diagram showing an example of a light passing characteristic of a typical WDM coupler.

### DETAILED DESCRIPTION OF THE INVENTION

Hereunder is a description of embodiments of the present invention with reference to the drawings. The same reference symbols are used to the same or similar parts throughout all the drawings.

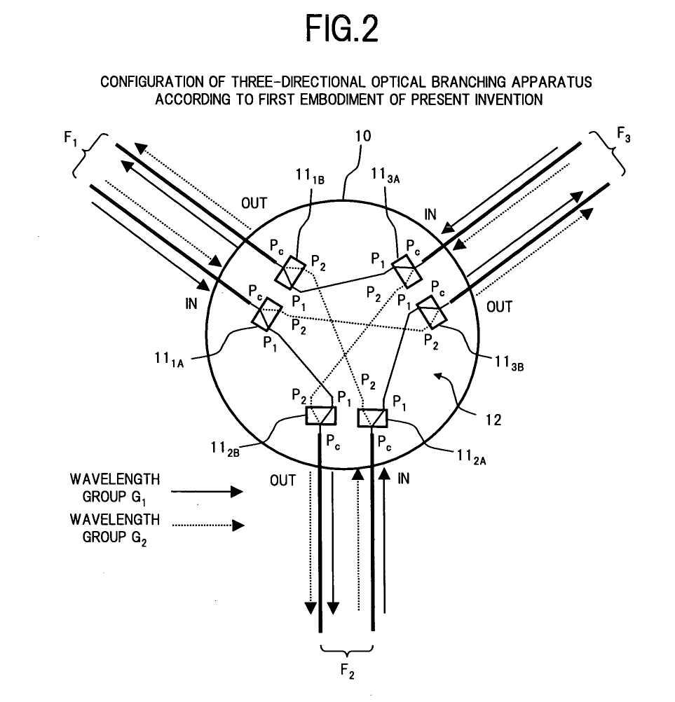

FIG. 2 is a block diagram of a multi-directional optical branching apparatus according to a first embodiment of the present invention.

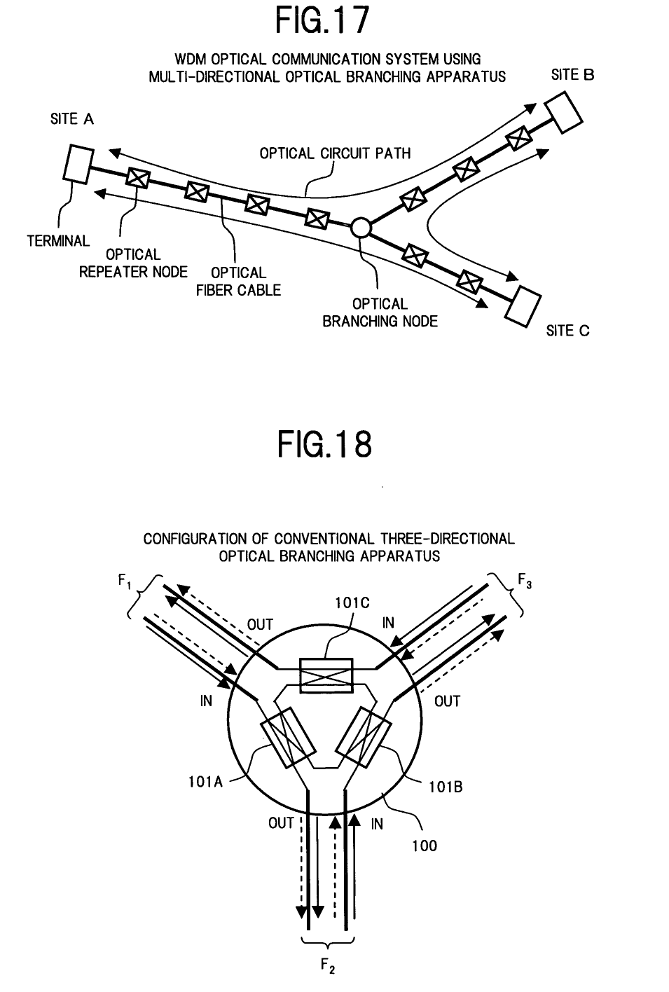

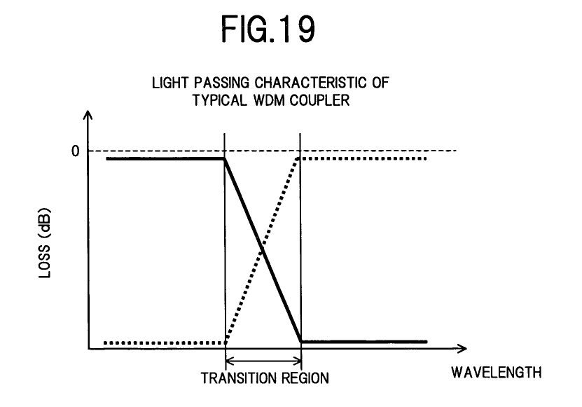

In FIG. 2, in a multi-directional optical branching apparatus 10 of the present embodiment using, for example, six optical multiplexing/demultiplexing devices 11_{1A}, 11_{1B}, 11_{2A}, 11_{2B}, 11_{3A}, and 11_{3B} each having one common port P_{C} and two branch ports P₁ and P₂, WDM signal lights input from optical fiber pairs F₁, F₂, and F₃ as optical transmission paths corresponding to three directions are respectively demultiplexed into two wavelength groups G₁ and G₂, to be multiplexed with optical signals of different wavelength groups from other directions, and then, output to a predetermined optical fiber pair. This three-directional optical branching apparatus 10 is used for example in the optical branching node of the WDM optical transmission system shown in FIG. 17.

The optical multiplexing/demultiplexing devices 11_{1A} and 11_{1B} are provided corresponding to the optical fiber pair F₁. An input fiber IN corresponding to an input side optical path of the optical fiber pair F₁ is connected with the common port P_{C} of the optical multiplexing/demultiplexing device 11_{1A}, and an output fiber OUT corresponding to an output side optical path of the optical fiber pair F₁ is connected with the common port P_{C} of the optical multiplexing/demultiplexing device 11_{1B}. In the same way, an input fiber IN and an output fiber OUT of the optical fiber pair F₂ are respectively connected with the common ports P_{C} of the optical multiplexing/demultiplexing devices 11_{2A} and 11_{2B}, and an input fiber IN and an output fiber OUT of the optical fiber pair F₃ are respectively connected with the common ports P_{C} of the optical multiplexing/demultiplexing devices 11_{3A} and 11_{3B}. The respective branch ports P₁ and P₂ of the optical multiplexing/demultiplexing devices 11_{1A}, 11_{1B} to 11_{3A}, 11_{3B} are connected in one to one by a branch port connecting section 12, in accordance with the aforementioned first through third connection rules. This one to one connection method between the branch ports will be discussed later.

In the respective optical multiplexing/demultiplexing devices 11_{1A}, 11_{1B} to 11_{3A}, 11_{3B}, in the case where WDM signal light containing a plurality of optical signals in a usable wavelength band is input to the common port P_{C}, the WDM signal light is demultiplexed into two wavelength groups G₁ and G₂, to be output from the corresponding branch ports P₁ and P₂. Also, in the case where optical signals belonging to the wavelength groups G₁ and G₂ are input to the branch ports P₁ and P₂ corresponding to these wavelength groups, the optical signals of the respective input wavelength groups G₁ and G₂ are multiplexed to be output from the common port P_{C}.

As a specific device provided with such an optical multiplexing/demultiplexing function, for example, a bulk-type WDM coupler or the like which uses a fusion-type WDM coupler or a dielectric multi-layer filter, can be used. As a further example, it is also possible to use an optical interleaver and the like which applies a Mach-Zehnder interferometer or a GT interferometer or the like.

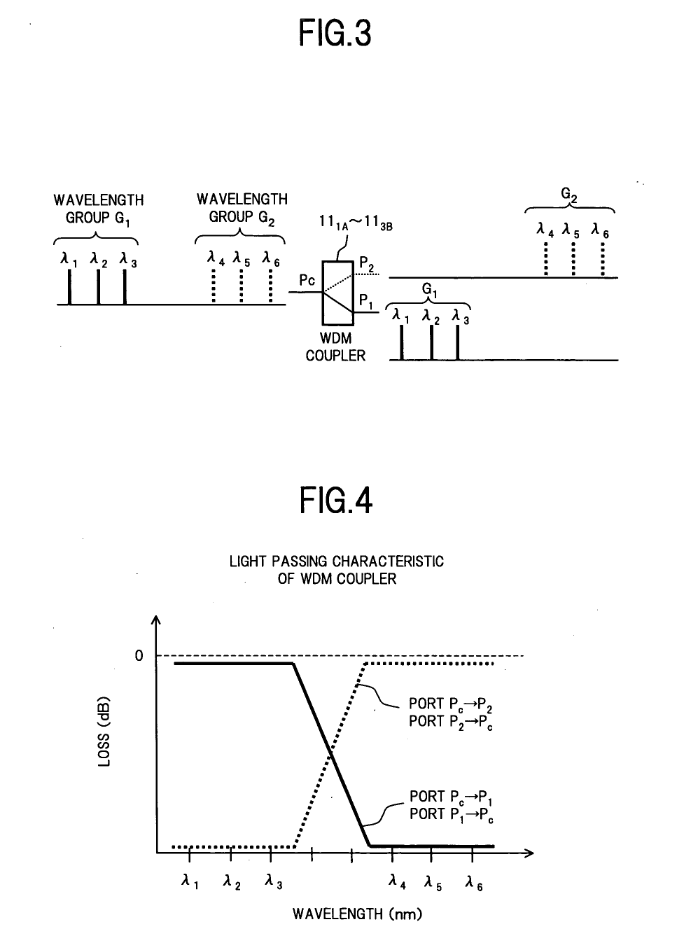

FIG. 3 and FIG. 4 exemplify a function and a characteristic realized in the case where WDM couplers are used as the optical multiplexing/demultiplexing devices 11_{1A}, 11_{1B} to 11_{3A}, 11_{3B}. In light passing characteristics between respective ports of the WDM coupler, as shown in FIG. 4, a loss (solid line) between the common port P_{C} and the branch port P₁ is reduced on a short wavelength side, and a loss (dotted line) between the common port P_{C} and the branch port P₂ is reduced on a long wavelength side. Therefore, with a region where the light passing characteristics corresponding to the respective branch ports P₁ and P₂ transit as a boundary, the optical signals belonging to the short wavelength side are set to the wavelength group G₁, and the optical signals belonging to the long wavelength side are set to the wavelength group G₂. By such setting of the wavelength groups G₁ and G₂, when WDM signal light containing optical signals of wavelengths λ₁ to λ₆, as shown on the left in FIG. 3, is input to the common port P_{C}, then as shown on the lower right in FIG. 3, optical signals of wavelengths λ₁ to λ3 belonging to the wavelength group G₁ are output from the branch port P₁, and as shown on the upper right in FIG. 3, optical signals of wavelengths λ₄to λ₆ belonging to the wavelength group G₂ are output from the branch port P₂. Contrary to this, when optical signals of wavelengths λ₁ to λ₃ are input to the branch port P₁, and optical signals of wavelengths λ₄ to λ₆ are input to the branch port P₂, WDM signal light obtained by multiplexing the optical signals of wavelengths λ₁ to λ₆ is output from the common port P_{C}.

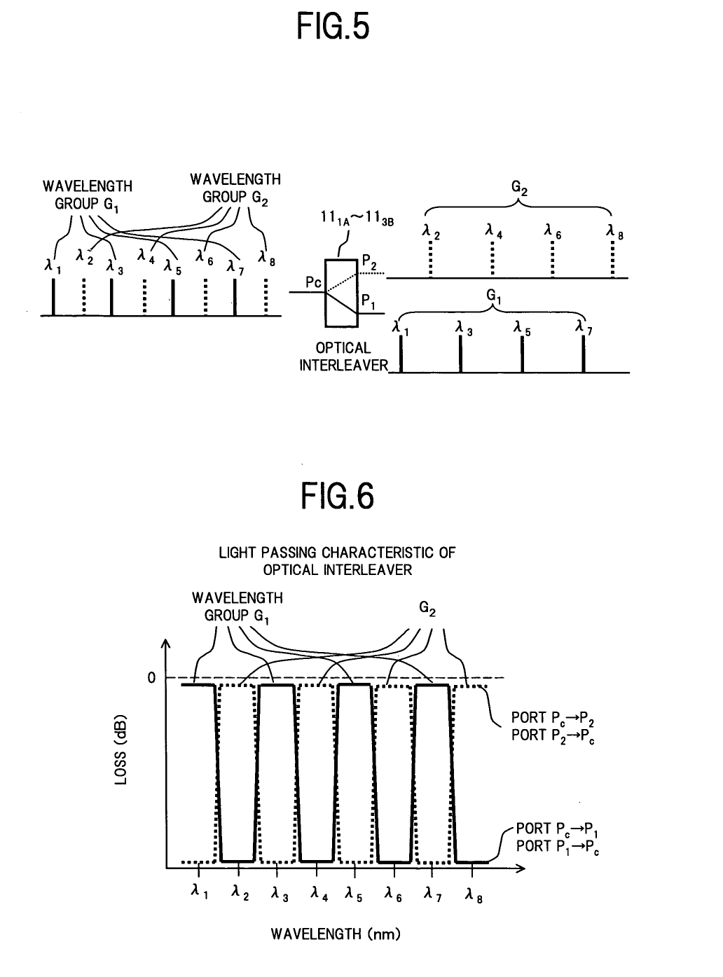

FIG. 5 and FIG. 6 exemplify a function and a characteristic realized in the case where optical interleavers are used as the optical multiplexing/demultiplexing devices 11_{1A}, 11_{1B} to 11_{3A}, 11_{3B}. In the optical interleaver, as shown in FIG. 6, since a light passing characteristic between the common port P_{C} and the branch port P₁ (solid line) and a light passing characteristic between the common port P_{C} and the branch port P₂ (dotted line) are periodically varied in a comb teeth shape with respect to the wavelengths, a plurality of optical signals arranged at equal wavelength intervals can be alternately multiplexed/demultiplexed. Corresponding to such characteristics of the optical interleaver, here, regarding the optical signals of wavelengths λ₁ to λ₈ arranged in the equal intervals, the optical signals of odd-numbered wavelengths are set to the wavelength group G₁, and the optical signals of even-numbered wavelengths are set to the wavelength group G₂. By such wavelength group G₁, G₂ setting, when WDM signal light containing optical signals of wavelengths λ₁ to λ₈ as shown on the left in FIG. 5 is input to the common port P_{C}, then as shown on the lower right in FIG. 5, optical signals of wavelengths λ₁, λ₃, λ₅ and λ₇ belonging to the wavelength group G₁ are output from the branch port P₁, and as shown on the upper right in FIG. 5, optical signals of wavelengths λ₂, λ₄, λ₆ and λ₈ belonging to the wavelength group G₂ are output from the branch port P₂. Contrary to this, when optical signals of odd-numbered wavelengths are input to the branch port P₁, and optical signals of even-numbered wavelengths are input to the branch port P₂, WDM signal light obtained by multiplexing the optical signals of wavelengths λ₁ to λ₈ is output from the common port P_{C}.

In the case where the WDM couplers are used as the optical multiplexing/demultiplexing devices 11_{1A}, 11_{1B} to 11_{3A}, 11_{3B}, a transition region of required width occurs between the short wavelength side region and the long wavelength side region, and optical signals can not be arranged within this transition region. Therefore, there is a disadvantage in that the usable wavelength band is limited. On the other hand, in the case where the optical interleavers are used, the light passing characteristics between respective ports are varied sharply. Therefore, the above disadvantage in that the wavelength band is limited is resolved.

Here is a specific description of the connection method for respective branch ports P₁ and P₂ of the optical multiplexing/demultiplexing devices 11_{1A}, 11_{1B} to 11_{3A}, 11_{3B}.

As described above, between the respective branch ports P₁ and P₂ is connected in one to one by the branch port connecting section 12, in accordance with the first through third connection rules (provided N=3). Specifically, as the first connection rule, the branch ports P₁ and P₂ of the optical multiplexing/demultiplexing device 11_{jA} which has been connected with the input fiber IN of certain optical fiber pair Fⱼ (j=1 to 3) among the optical fiber pairs F₁ to F₃, are connected in one to one with the branch ports P₁ and P₂ of the optical multiplexing/demultiplexing device 11_{kB} which has been connected with the output fiber OUT of the other optical fiber pair Fₖ(k≠j).

Also, as the second connection rule, the branch ports corresponding to the same wavelength group, that is, the branch ports P₁ corresponding to an index [1] of the wavelength group G₁, are connected with each other, and also the branch ports P₂ corresponding to an index [2] of the wavelength group G₂ are connected with each other. In other words, the connection between the branch ports P₁ and P₂ having different wavelength group indexes is inhibited.

Moreover, as the third connection rule, for all of the combinations (Fₗ, Fₘ) of selection of any two from the optical fiber pairs F₁ to F₃ (provided m≠I and I, m=1 to 3), between the branch ports are connected so that the up-link path and the down-link path are linked. That is to say, the connection between the branch ports of the optical multiplexing/demultiplexing devices 11_{1A}, 11_{mA} where the common ports P_{C} thereof have been connected with the input fibers IN, or between the branch ports of the optical multiplexing/demultiplexing devices 11_{IB}, 11_{mB} where the common ports P_{C} thereof have been connected with the output fibers OUT, is inhibited.

So as to satisfy all the above first through third connection rules, the following Table 1 shows the port connections for when between the total twelve of the branch ports P₁ and P₂ of the optical multiplexing/demultiplexing devices 11_{1A}, 11_{1B} to 11_{3A}, 11_{3B} are connected in one to one.

TABLE 1

| OUT | | |
|---|---|---|
| F1 | F2 | F3 |

| IN | | P₁ | P₂ | P₁ | P₂ | P₁ | P₂ |
|---|---|---|---|---|---|---|---|
| F₁ | P₁ | | — | ◯ | — | X | — |
| | P₂ | — | | — | X | — | ◯ |
| F₂ | P₁ | X | — | | — | ◯ | — |
| | P₂ | — | ◯ | — | | — | X |
| F₃ | P₁ | ◯ | — | X | — | | — |
| | P₂ | — | X | — | ◯ | — | |

In the above Table 1, the symbol “◯” denotes the branch ports which are connected in one to one, the symbol “X” denotes the branch ports which are not connected corresponding to the branch ports of “◯” symbol, and the symbol “-” denotes the branch ports the connection of which is inhibited. By such connection between branch ports, the allocation of the wavelength groups G₁ and G₂ for the optical path which is formed with respect to the three-directional optical fiber pairs F₁ to F₃ is set as shown in the following Table 2.

TABLE 2

OUT

| IN | F₁ | F₂ | F₃ |
|---|---|---|---|
| F₁ | | G₁ | G₂ |
| F₂ | G₂ | | G₁ |
| F₃ | G₁ | G₂ | |

As shown in Table 2, regarding the WDM signal light from the input fiber IN of the optical fiber pair F₁, the optical signals belonging to the wavelength group G₁ are output to the output fiber OUT of the optical fiber pair F₂, and the optical signals belonging to the wavelength group G₂ are output to the output fiber OUT of the optical fiber pair F₃. Also, regarding the WDM signal light from the input fiber IN of the optical fiber pair F₂, the optical signals belonging to the wavelength group G₁ are output to the output fiber OUT of the optical fiber pair F₃, and the optical signals belonging to the wavelength group G₂ are output to the output fiber OUT of the optical fiber pair F₁. Moreover, regarding the WDM signal light from the input fiber IN of the optical fiber pair F₃, the optical signals belonging to the wavelength group G₁ are output to the output fiber OUT of the optical fiber pair F₁, and the optical signals belonging to the wavelength group G₂ are output to the output fiber OUT of the optical fiber pair F₂.

By such allocation of the wavelength groups G₁ and G₂, the up-links and down-links are ensured mutually between the three-directional optical fiber pairs F₁ to F₃. For example, the wavelength group G₁ is allocated to the optical path from the optical fiber pair F₁ to the optical fiber pair F₂, and the wavelength group G₂ is allocated to the reverse optical path from the optical fiber pair F₂ to the optical fiber pair F₁, so that the up-links and down-links for different wavelength groups are ensured between the optical fiber pairs F₁ and F₂.

For the up-links and down-links ensured between the optical fiber pairs F₁ to F₃ as described above, normally, it is necessary to allocate equal transmission capacity. Therefore, when the number of wavelengths of the optical signals contained in the wavelength group G₁ is set either higher or lower than the number of wavelengths of the optical signals contained in the wavelength group G₂, then due to the smaller numbers of wavelengths, the entire usable wavelength number will be limited. Accordingly, it is desirable that the setting of the respective wavelength groups G₁ and G₂ is performed such that the number of wavelengths contained in the respective wavelength groups G₁ and G₂ become equal. Thus, it becomes possible to use the wavelength band most effectively.

According to the three-directional optical branching apparatus 10 of the above first embodiment, it becomes possible to perform the demultiplexing and multiplexing of optical signals collectively for each of the previously set wavelength groups G₁ and G₂, using the six optical multiplexing/demultiplexing devices 11_{1A}, 11_{1B} to 11_{3A}, 11_{3B}. Therefore, since the process as in the conventional technique in which the WDM signal light is demultiplexed for each one wave, and then re-multiplexed to be sent in the required direction becomes unnecessary, and it is no longer necessary to perform complicated wiring, it becomes possible to realize a low cost and low loss optical branching apparatus with a simple configuration.

Also, compared to the conventional three-directional optical branching apparatus using three WDM couplers as shown in FIG. 18, in the three-directional optical branching apparatus 10 of the present embodiment, the optical signals passing through the respective optical paths within the apparatus necessarily pass through two optical multiplexing/demultiplexing devices, and thus receive the same amount of loss. Therefore, it becomes possible to easily achieve power balance (the balance between the optical signal power of the wavelength group G₁ and the optical signal power of the wavelength group G₂ after the multiplication) of the WDM signal lights output to the output fibers OUT of the optical fiber pairs F₁ to F₃. Moreover, even if there are variations of loss in the respective optical multiplexing/demultiplexing devices, resulting in conditions where the optical signals passing through the respective optical paths do not always receive the same amount of loss, in the configuration of the present optical branching apparatus 10, it is also possible to compensate for a deviation of the optical signal power between the respective wavelength groups G₁ and G₂ by providing power adjustment means such as for example a variable optical attenuator or an optical amplifier. An embodiment provided with this power adjustment means will be described later.

Next is a description of a multi-directional optical branching apparatus according to a second embodiment of the present invention.

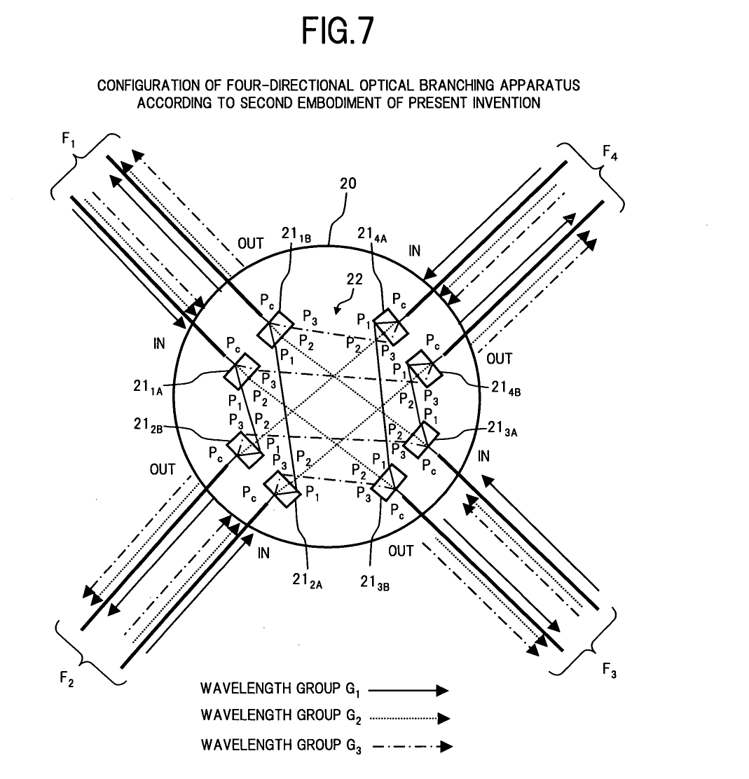

FIG. 7 is a block diagram of the multi-directional optical branching apparatus of the second embodiment.

In FIG. 7, in the present multi-directional optical branching apparatus 20 using, for example, eight optical multiplexing/demultiplexing devices 21_{1A}, 21_{1B}, 21_{2A}, 21_{2B}, 21_{3A}, 21_{3B}, 21_{4A}, and 21_{4B} each having one common port P_{C} and three branch ports P₁, P₂ and P₃, WDM signal lights input from optical fiber pairs F₁, F₂, F₃ and F₄ corresponding to four directions are respectively demultiplexed into three wavelength groups G₁, G₂ and G₃, to be multiplexed with optical signals of different wavelength groups from other directions, and then output to a predetermined optical fiber pair.

For this four-directional optical branching apparatus 20 also, similarly to the configuration of the three directional optical branching apparatus 10 as described above, an input fiber IN and an output fiber OUT of the optical fiber pair F₁ are respectively connected with the common ports P_{C} of the optical multiplexing/demultiplexing devices 21_{1A} and 21_{1B}, and an input fiber IN and an output fiber OUT of the optical fiber pair F₂ are respectively connected with the common ports P_{C} of the optical multiplexing/demultiplexing devices 21_{2A} and 21_{2B}. Moreover, an input fiber IN and an output fiber OUT of the optical fiber pair F₃ are respectively connected with the common ports P_{C} of the optical multiplexing/demultiplexing devices 21_{3A} and 21_{3B}, and an input fiber IN and an output fiber OUT of the optical fiber pair F₄ are respectively connected with the common ports P_{C} of the optical multiplexing/demultiplexing devices 21_{4A} and 21_{4B}. Then, the respective branch ports P₁ to P₃ (24 in total) of each of the eight optical multiplexing/demultiplexing devices 21_{1A}, 21_{1B} to 21_{4A}, 21_{4B} are connected in one to one by a branch port connecting section 22, in accordance with the first through third connection rules.

In the respective optical multiplexing/demultiplexing devices 21_{1A}, 21_{1B} to 21_{4A}, 21_{4B}, in the case where the WDM signal light containing a plurality of optical signals in a usable wavelength band is input to each of the common ports P_{C}, the WDM signal light is demultiplexed into three wavelength groups G₁ to G₃ to be output from the corresponding branch ports P₁ to P₃. Also, in the case where the optical signals belonging to the wavelength groups G₁ to G₃ are input to the branch ports P₁ to P₃ corresponding to these wavelength groups, the optical signals of the respective input wavelength groups G₁ to G₃ are multiplexed to be output from the common ports P_{C}.

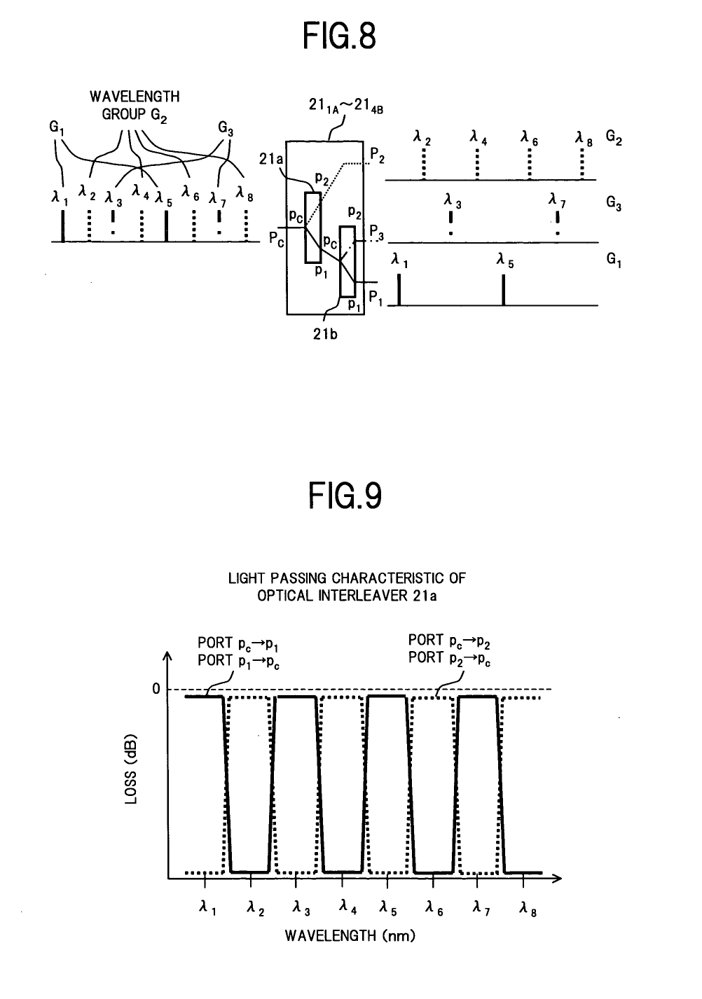

The respective optical multiplexing/demultiplexing devices 21_{1A}, 21_{1B} to 21_{4A}, 21_{4B} for realizing the above function, for example, as shown in the central part of FIG. 8, can be realized by cascade connecting optical interleavers 21a and 21b each having one common port P_{C} and two branch ports p₁ and p₂. Specifically, in the former stage optical interleaver 21a, the common port P_{C} serves as the common port P_{C} of the optical multiplexing/demultiplexing device, the branch port p₁ is connected to the common port P_{C} of the latter stage optical interleaver 21b, and the branch port p₂serves as the branch port P₂ of the optical multiplexing/demultiplexing device. The two branch ports p₁ and p₂ of the latter stage optical interleaver 21b respectively serve as the branch ports P₁ and P₃ of the optical multiplexing/demultiplexing device.

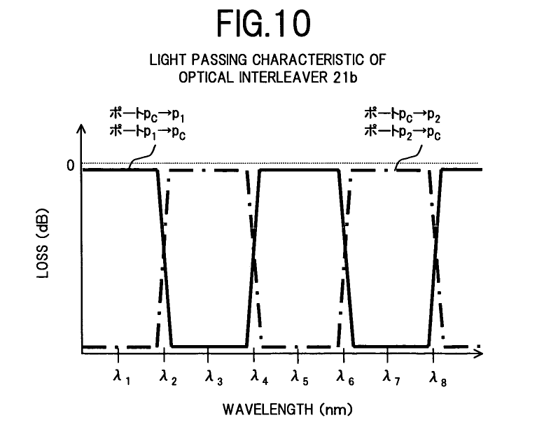

The former stage optical interleaver 21a has light passing characteristics between respective ports, for example as shown in FIG. 9, and optical signals of odd-numbered wavelengths are input and output with respect to the branch port p₁, and optical signals of even-numbered wavelengths are input and output with respect to the branch port p₂. On the other hand, the latter stage optical interleaver 21b has, for example as shown in FIG. 10, light passing characteristics which change at a period twice the light passing characteristics of the former stage optical interleaver 21a, and therefore is capable of further demultiplexing the optical signals of odd-numbered wavelengths from the former stage optical interleaver 21a into two groups, to output the optical signals of wavelengths λ₁ and λ₅ to the branch port p₁, and to output the optical signals of wavelengths λ₃ and λ₇ to the branch port p₂.

Corresponding to the characteristics of the optical multiplexing/demultiplexing device comprising such optical interleavers 21a and 21b, here, regarding the optical signals of wavelengths λ₁ to λ₈ which are arranged in equal intervals, the optical signals of wavelengths λ₁ and λ₅ are set to the wavelength group G₁, the optical signals of even-numbered wavelengths λ₂, λ₄, λ₆ and λ₈ are set to the wavelength group G₂, and the optical signals of wavelengths λ₃ and λ₇ are set to the wavelength group G₃. By such setting of wavelength groups G₁ to G₃, when WDM signal light containing optical signals of wavelengths λ₁ to λ₈ as shown on the left in FIG. 8 is input to the common port P_{C} of the optical multiplexing/demultiplexing device, the optical signals of wavelengths λ₁ and λ₅ belonging to the wavelength group G₁ are output from the branch port P₁ (lower right in FIG. 8), the optical signals of wavelengths λ₂, λ₄, λ₆ and λ₈ belonging to the wavelength group G₂ are output from the branch port P₂ (upper right in FIG. 8), and moreover the optical signals of wavelengths λ₃ and λ₇ belonging to the wavelength group G₃ are output from the branch port P₃ (middle right in FIG. 8). Contrary to this, when the optical signals of wavelengths λ₁ and λ₅ are input to the branch port P₁, the optical signals of even-numbered wavelength are input to the branch port P₂, and the optical signals of wavelengths λ₃ and λ₇ are input to the branch port P₃, then the WDM signal light obtained by multiplexing the optical signals of wavelength λ₁ to λ₈ is output from the common port P_{C}.

Between the respective branch ports P₁ to P₃ of the respective optical multiplexing/demultiplexing devices 21_{1A}, 21_{1B} to 21_{4A}, 21_{4B} is connected in one to one by the branch port connecting section 22, in accordance with the first through third connection rules. The specific connection method may be considered similarly to the above first embodiment. Therefore, here, by showing a port connection table in the four-directional optical branching apparatus 20 in the following Table 3, and showing the allocation of the wavelength groups G₁ to G₃ for the optical paths formed with respect to the optical fiber pairs F₁ to F₄, in Table 4, specific description is omitted.

TABLE 3

| | | OUT | | | | | | | | | | | |
|---|---|---|---|---|---|---|---|---|---|---|---|---|---|
| | | F₁ | | | F₂ | | | F₃ | | | F₄ | | |
| IN | | P₁ | P₂ | P₃ | P₁ | P₂ | P₃ | P₁ | P₂ | P₃ | P₁ | P₂ | P₃ |
| F₁ | P₁ | | — | — | ◯ | — | — | X | — | — | X | — | — |
| | P₂ | — | | — | — | X | — | — | ◯ | — | — | X | — |
| | P₃ | — | — | | — | — | X | — | — | X | — | — | ◯ |
| F₂ | P₁ | ◯ | — | — | | — | — | X | — | — | X | — | — |
| | P₂ | — | X | — | — | | — | — | X | — | — | ◯ | — |
| | P₃ | — | — | X | — | — | | — | — | ◯ | — | — | X |
| F₃ | P₁ | X | — | — | X | — | — | | — | — | ◯ | — | — |
| | P₂ | | ◯ | — | — | X | — | — | | — | — | X | — |
| | P₃ | | — | X | — | — | ◯ | — | — | | — | — | X |
| F₄ | P₁ | X | — | — | X | — | — | ◯ | — | — | | — | — |
| | P₂ | — | X | — | — | ◯ | — | — | X | — | — | | — |
| | P₃ | — | — | ◯ | — | — | X | — | — | X | — | — | |

TABLE 4

OUT

| IN | F₁ | F₂ | F₃ | F₄ |
|---|---|---|---|---|
| F₁ | | G₁ | G₂ | G₃ |
| F₂ | G₁ | | G₃ | G₂ |
| F₃ | G₂ | G₃ | | G₁ |
| F₄ | G₃ | G₂ | G₁ | |

According to the four-directional optical branching apparatus 20 of the above second embodiment, It becomes possible to perform the demultiplexing and multiplexing of optical signals for each of the three wavelength groups G₁ to G₃ by combining the eight optical multiplexing/demultiplexing devices 21_{1A}, 21_{1B} to 214A, 21_{4B}. Thus, also for the configuration corresponding to four directions, similar effects to the aforementioned first embodiment can be obtained. Moreover, similarly to the four-directional optical branching apparatus 20 of the second embodiment, it is also possible to realize an optical branching apparatus corresponding to five or more directions, and the present invention is effective for an optical branching apparatus corresponding to N directions (N≧3).

In the aforementioned embodiments, for the optical branching apparatus corresponding to N directions, there has been described the case where each of the 2×N optical multiplexing/demultiplexing devices has one common port P_{C} and N−1 branch ports P₁ to P_{N-1}. However, even in the case where each of the optical multiplexing/demultiplexing devices physically has one common port P_{C} and M (M>N−1) branch ports P₁ to P_{M}, it is possible to connect between each of the branch ports by grouping the M branch ports P₁ to P_{M} and virtually considering these as N−1 branch ports.

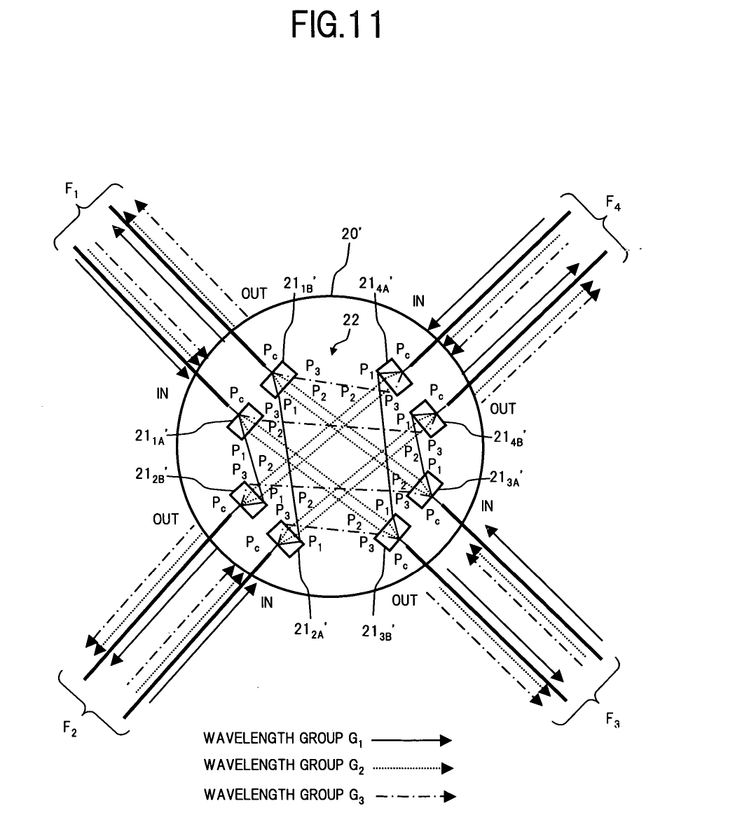

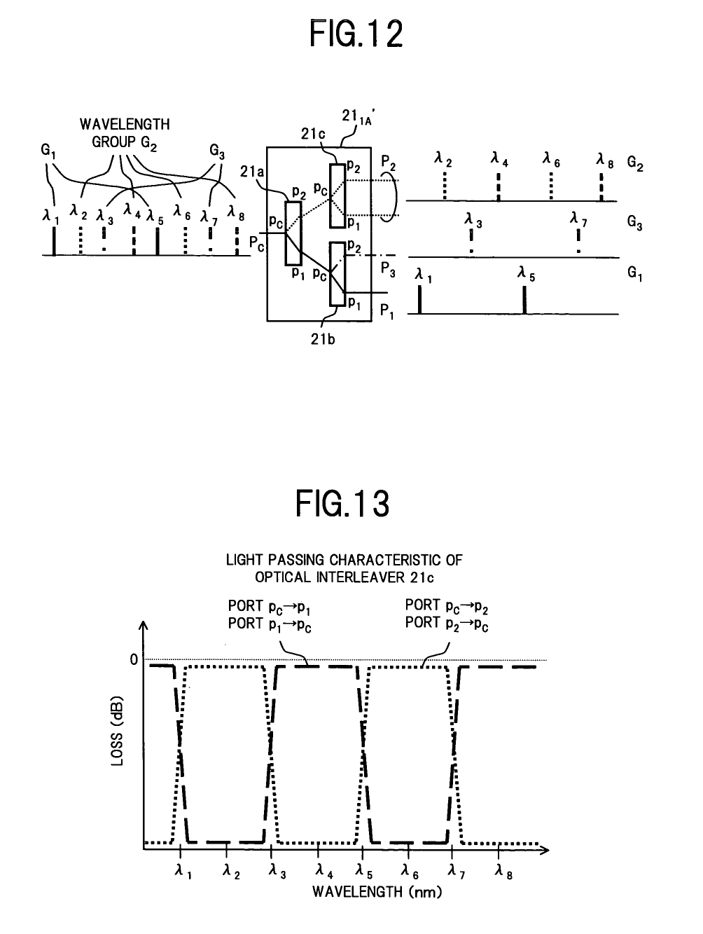

FIG. 11 is a block diagram showing an example of the case where the above consideration is applied to the four-directional optical branching apparatus 20 shown in FIG. 7. In a four-directional optical branching apparatus 20′ shown in FIG. 11, eight optical multiplexing/demultiplexing devices 21_{1A}′, 21_{1B}′ to 21_{4A}′, 21_{4B}′ each having one common port P_{C} and four branch ports P₁ to P₄ are used. These optical multiplexing/demultiplexing devices 21_{1A}′, 21_{1B}′ to 21_{4A}′, 21_{4B}′, as respectively shown in the central part of FIG. 12, are configured, using three optical interleavers 21a, 21b, and 21c each having one common port P_{C} and two branch ports p₁, p₂, to cascade connect in two stages the optical interleaver 21a, and the optical interleaver 21b and the optical interleaver 21c. This configuration is made by adding the optical interleaver 21c before the branch port P₂ of the optical interleaver 21a in the configuration of the optical multiplexing/demultiplexing device shown in FIG. 8. This optical interleaver 21c has similar characteristics to the light passing characteristics of the optical interleaver 21b (FIG. 10), as for example shown in FIG. 13.

In the optical multiplexing/demultiplexing device of such configuration, the total 4 branch ports of the optical interleavers 21b and 21c physically exist. However, by virtually considering two of these four branch ports (here for example the branch ports p₁ and p₂ of the optical interleaver 21c) to be one branch port P₂ (FIG. 12), it is possible to perform the connection with the branch ports of other optical multiplexing/demultiplexing devices (FIG. 11). The merit caused by such virtual grouping of the branch ports is in that there occurs a degree of freedom enabling for example, the circuit capacity between the input fibers IN and the output fibers OUT of the respective optical fiber pairs F₁ to F₄ to be adjusted.

Next is a description of a multi-directional optical branching apparatus according to a third embodiment of the present invention. Here, an application example is described where the balance of the optical signal power corresponding to the respective wavelength groups of the WDM signal light output to the optical fiber pairs becomes uniform with high accuracy.

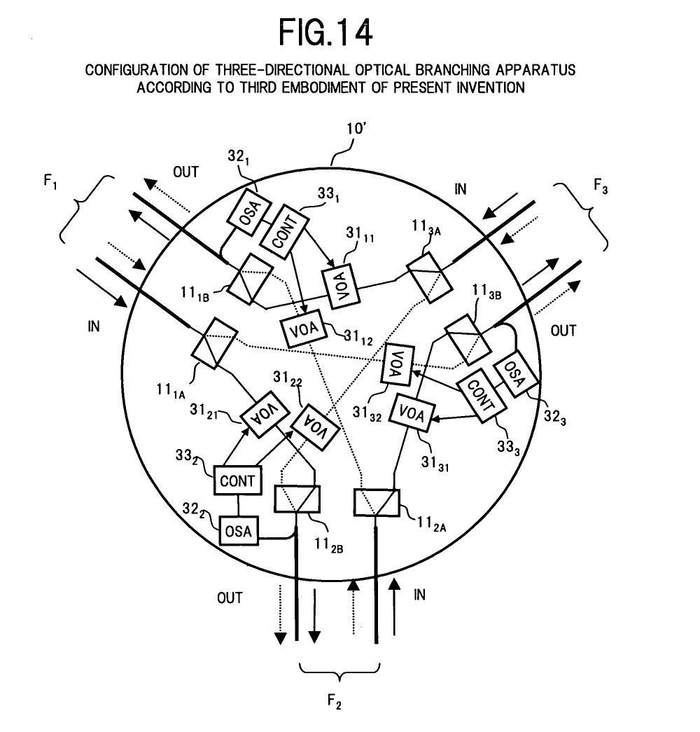

FIG. 14 is a block diagram of the multi-directional optical branching apparatus of the third embodiment.

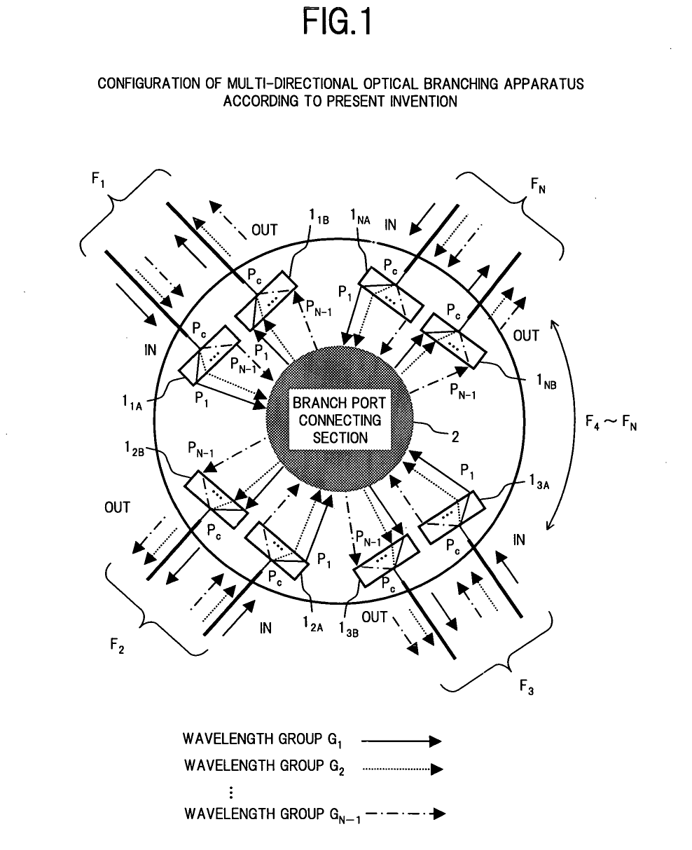

The multi-directional optical branching apparatus 10′ shown in FIG. 14 is configured such that variable optical attenuators (VOA) 31₁₁, 31₁₂, 31₂₁, 31₂₂, 31₃₁, and 31₃₂ which adjust the power of the optical signals being propagated are respectively arranged on the respective optical paths connecting between the respective branch ports P₁ and P₂ of the optical multiplexing/demultiplexing devices 11_{1A}, 11_{1B} to 11_{3A}, 11_{3B}, and also optical spectrum analyzers (OSA) 31₁, 31₂, and 31₃ and control circuits (CONT) 33₁, 33₂ and 33₃ for controlling the variable optical attenuators by monitoring the spectrum of the WDM signal light output to each of the optical fiber pairs F₁, F₂ and F₃ are respectively provided, for example, in the three-directional optical branching apparatus of the aforementioned first embodiment shown in FIG. 1,.

The variable optical attenuators 31₁₁ and 31₁₂ are provided on the optical paths linked to the respective branch ports P₁ and P₂ of the optical multiplexing/demultiplexing device 11_{1B} connected with the output fiber OUT of the optical fiber pair F₁, and the optical attenuations thereof are controlled by the control circuit 33₁ according to the monitoring result of the optical spectrum analyzer 32₁. The optical spectrum analyzer 32₁ extracts a part of the WDM signal light which has been sent from the common port P_{C} of the optical multiplexing/demultiplexing device 11_{1B} to the output fiber OUT of the optical fiber pair F₁, to detect the optical spectrum, and outputs the detection result to the control circuit 33₁. The control circuit 33₁ feedback controls the respective optical attenuations of the variable optical attenuators 31₁₁ and 31₁₂ based on optical spectrum information from the optical spectrum analyzer 32₁, so that the average power of the optical signals belonging to the wavelength group G₁ and the average power of the optical signals belonging to the wavelength group G₂ are approximately the same.

The variable optical attenuators 31₂₁ and 31₂₂ are provided on the optical paths linked to the respective branch ports P₁ and P₂ of the optical multiplexing/demultiplexing device 11_{2B} connected with the output fiber OUT of the optical fiber pair F₂, and similarly to the variable optical attenuators 31₁₁ and 31₁₂ above, the optical attenuations thereof are feedback controlled by the control circuit 33₂ according to the monitoring result of the optical spectrum analyzer 32₂. Also, the variable optical attenuators 31₃₁ and 31₃₂ are provided on the optical paths linked to the respective branch ports P₁ and P₂ of the optical multiplexing/demultiplexing device 11_{3B} connected with the output fiber OUT of the optical fiber pair F₃, and the optical attenuations thereof are feedback controlled by the control circuit 33₃ according to the monitoring result of the optical spectrum analyzer 32₃. The optical spectrum analyzers 32₂ and 32₃ and the control circuits 33₂ and 33₃ are similar to the optical spectrum analyzer 32₁ and the control circuit 33₁ described above.

In the three-directional optical branching apparatus 10′ of the above configuration, even in the case where a significant error in loss occurs in the six optical multiplexing/demultiplexing devices 11_{1A}, 11_{1B} to 11_{3A}, 11_{3B}, or WDM signal lights of different optical power are input from the input fibers IN of the respective optical fiber pairs F₁ to F₃ to the optical multiplexing/demultiplexing devices 1_{1A} to 1_{3A}, the WDM signal lights sent from the respective optical multiplexing/demultiplexing devices 1_{1B} to 1_{3B} to the output fibers OUT of the respective optical fiber pairs F₁ to F₃ are monitored by the respective optical spectrum analyzers 32₁ to 32₃ to detect unbalance of the average optical power for the wavelength groups G₁ and G₂, and the optical attenuations of the corresponding variable optical attenuators 31₁₁, 31₁₂ to 31₃₁, 31₃₂ are feedback controlled so that such unbalance is corrected. Thus, the WDM signal lights where the power is uniform in the usable wavelength band can be output to the respective output fibers OUT of the optical fiber pairs F₁ to F₃. As a result, it becomes possible to stabilize the transmission of the WDM signal light to the respective directions.

In the above third embodiment, there has been described the case where the power of the optical signals of the respective wavelength groups G₁ and G₂ is adjusted by the variable optical attenuators 31₁₁, 31₁₂ to 31₃₁, 31₃₂. However, the power of the optical signals may be adjusted by using typical optical amplifiers instead of the variable optical attenuators. In this case, driving states of the optical amplifiers are feedback controlled by the respective control circuits 32₁ to 32₃.

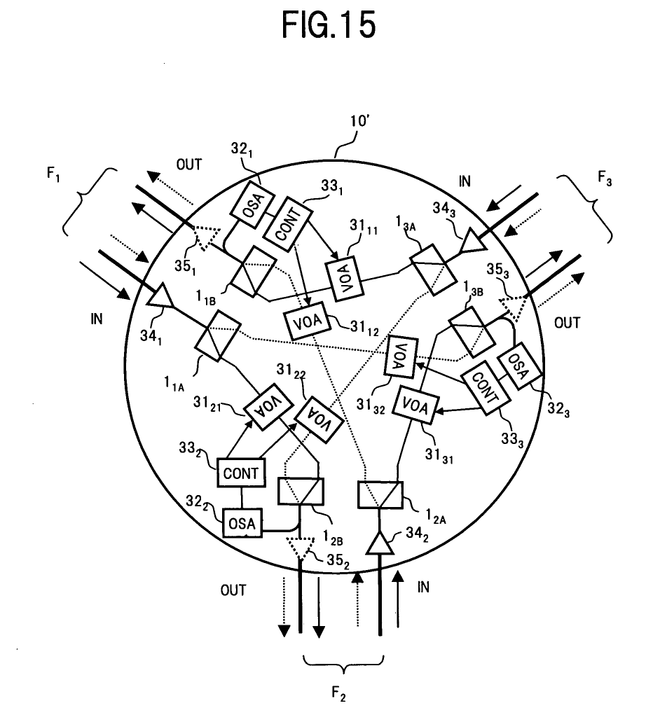

Also, as a modified example of the above third embodiment, for example as shown in FIG. 15, optical amplifiers 34₁ to 34₃ may be respectively provided between the input fibers IN of the optical fiber pairs F₁ to F₃ and the common ports P_{C} of the respective optical multiplexing/demultiplexing devices 1_{1A} to 1_{3A}, so as to compensate for losses occurring in each optical multiplexing/demultiplexing device and each variable optical attenuator within the optical branching apparatus 10′. Moreover, as shown by the dotted lines in FIG. 15, the configuration may be such that, in addition to the above optical amplifiers 34₁ to 34₃, optical amplifiers 35₁ to 35₃ are also provided between the output fibers OUT of the optical fiber pairs F₁ to F₃ and the common ports P_{C} of the respective optical multiplexing/demultiplexing devices 1_{1B} to 1_{3B}, so as to compensate for losses on both the input and the output sides.

Next is a description of a multi-directional optical branching apparatus according to a fourth embodiment of the present invention. Here, similarly to the above third embodiment, another application example is described where a power balance control of the WDM signal power is performed.

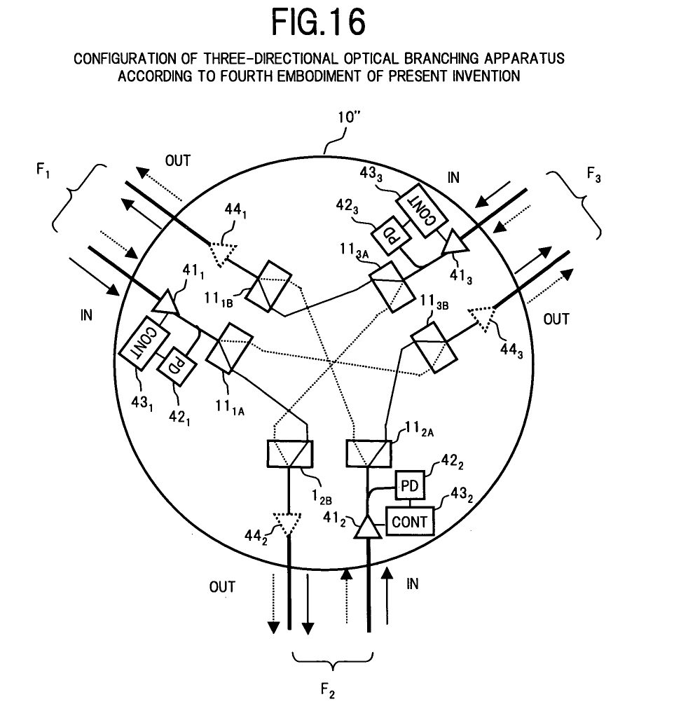

FIG. 16 is a block diagram of the multi-directional optical branching apparatus of the fourth embodiment.

In the multi-directional optical branching apparatus 10″ shown in FIG. 16, for example, optical amplifiers 41₁, 41₂ and 41₃ are respectively provided between input fibers IN of the optical fiber pairs F₁ to F₃ and the common ports P_{C} of the respective optical multiplexing/demultiplexing devices 11_{1A} to 11_{3A}, and also photodetectors (PD) 42₁, 42₂, and 42₃ and control circuits (CONT) 43₁, 43₂, and 43₃ for controlling driving states of the respective optical amplifiers 41₁ to 41₃ by monitoring the total power of the WDM signal lights output from the optical amplifiers 41₁ to 41₃ are respectively provided, in the above described three-directional optical branching apparatus of the first embodiment shown in FIG. 1.

The respective controlling circuits 43₁ to 43₃feedback control the driving state of the corresponding optical amplifiers 41₁ to 41₃, so that the power of the WDM signal lights monitored at the respective photodetectors 42₁ to 42₃ becomes constant at a predetermined level common to the respective directions.

In the optical branching apparatus 10″ of the above configuration, even in the case where the total power of the WDM signal lights input from the optical fiber pairs F₁ to F₃ differs from each other, by amplifying the respective WDM signal lights to the predetermined level by the corresponding optical amplifiers 41₁ to 41₃, the total power of the WDM signal lights given to the common ports P_{C} of the respective optical multiplexing/demultiplexing devices 11_{1A} to 11_{3A} becomes approximately uniform. In the six optical multiplexing/demultiplexing devices 11_{1A}, 11_{1B} to 11_{3A}, 11_{3B} within the optical branching apparatus 10″, there is also a possibility of variations occurring in the respective losses as in the above third embodiment. However basically, since it is possible to use the same device, it is easy to make these respective losses substantially the same. In the case where the same loss occurs in all of the optical multiplexing/demultiplexing devices 11_{1A}, 11_{1B} to 11_{3A}, 11_{3B}, then by uniformly controlling the total power of the WDM signal lights input from the respective optical fiber pairs F₁ to F₃, even for the WDM signal lights having passed through the respective optical multiplexing/demultiplexing devices 11_{1A}, 11_{1B} to 11_{3A}, 11_{3B} to be output to the respective optical fiber pairs F₁ to F₃, the power balance of the respective wavelength groups G₁ and G₂ can be made uniform. Also, by the amplification of the WDM signal lights in the optical amplifiers 41₁ to 41₃, it is also possible to compensate for losses occurring within the optical branching apparatus 10″.

In the case where variations occur in the respective losses in the optical multiplexing/demultiplexing devices 11_{1A}, 11_{1B} to 11_{3A}, 11_{3B}, by applying the configuration of the aforementioned third embodiment to the fourth embodiment, it becomes possible to control the power balance even more accurately. Moreover, losses occurring within the optical branching apparatus 10″ may be compensated for on both the input and output sides, by providing optical amplifiers 44₁ to 44₃ as shown by the dotted lines in FIG. 16, between the common ports P_{C} of the respective optical multiplexing/demultiplexing devices 11_{1B} to 11_{3B} and the output fibers OUT of the optical fiber pairs F₁ to F₃, in addition to the optical amplifiers 41₁ to 41₃ on the input side.

What is claimed is:

1. A multi-directional optical branching apparatus, connected to N (N≧3) optical transmission paths each having a pair of optical paths corresponding to an up-link and a down-link which transmit wavelength division multiplexed signal lights in mutually different directions, for demultiplexing a wavelength division multiplexed signal light input from an input side optical path of each of optical transmission paths into N−1 wavelength groups, and then multiplexing each demultiplexed group with optical signals of different wavelength groups from other directions to output the multiplexed signal light to each output side optical path of a predetermined optical transmission path, comprising:
2×N optical multiplexing/demultiplexing devices each including one common port which is connected in one to one with any one of the input side optical paths or the output side optical paths of said N optical transmission paths, and N−1 branch ports, and being capable of demultiplexing a wavelength division multiplexed signal light input to the common port into the respective wavelength groups, to output from the corresponding branch ports, and also multiplexing the optical signals, which belong to the respective wavelength groups, input to the branch ports, to output from the common port; and
a branch port connecting section that connects in one to one between the respective branch ports of said 2×N optical multiplexing/demultiplexing devices, in accordance with previously set connection rules.

2. A multi-directional optical branching apparatus according to claim 1,
wherein said branch port connecting section connects in one to one between the respective branch ports of said 2×N optical multiplexing/demultiplexing devices, to satisfy simultaneously; a first connection rule in that branch ports of an optical multiplexing/demultiplexing device where a common port thereof is connected with an input side optical path of one optical transmission path among said N optical transmission paths, are connected in one to one with branch ports of an optical multiplexing/demultiplexing device where a common port thereof is connected with an output side optical path of another optical transmission path; a second connection rule in that branch ports corresponding to the same wavelength group are connected with each other; and a third connection rule in that, for all of combinations where any two are selected from among said N optical transmission paths, between respective branch ports are connected so that the up-link path and the down-link path are respectively linked.

3. A multi-directional optical branching apparatus according to claim 1,
wherein said N−1 wavelength groups are set so that the number of wavelengths of the optical signals in the wavelength group allocated to the up-link, and the number of wavelengths of the optical signals in the wavelength group allocated to the down-link, become the same.

4. A multi-directional optical branching apparatus according to claim 1,
wherein said optical multiplexing/demultiplexing devices use WDM couplers which perform multiplexing/demultiplexing of optical signals, with an adjacent plurality of optical signals of wavelengths, contained in each transmission region, of light passing characteristics corresponding to respective branch ports, as a single wavelength group.

5. A multi-directional optical branching apparatus according to claim 1,
wherein said optical multiplexing/demultiplexing devices use optical interleavers each having light passing characteristics which are periodically varied in a comb teeth shape corresponding to the respective branch ports, which alternately multiplex/demultiplex optical signals arranged at equal wavelength intervals.

6. A multi-directional optical branching apparatus according to claim 1,
wherein when N≧4, for said optical multiplexing/demultiplexing devices, one common port and N−1 branch ports are formed by cascade connecting a plurality of devices each having one common port and two branch ports.

7. A multi-directional optical branching apparatus according to claim 6,
wherein, when the physical branch ports formed by cascade connecting the optical multiplexing/demultiplexing is M (M>N−1), said branch port connecting section groups two or more branch ports of said M branch ports, and virtually considers these as N branch ports, and connects between each of the branch ports.

8. A multi-directional optical branching apparatus according to claim 1, further comprising:
2×N power adjusting devices provided on the respective optical paths connecting between the respective branch ports of said optical multiplexing/demultiplexing devices, which adjust the power of optical signals being propagated within said optical path;
optical spectrum monitor sections that respectively monitor the optical spectrums of the wavelength division multiplexed signal lights output from common ports of said optical multiplexing/demultiplexing devices to the output side optical paths of said optical transmission paths; and
control sections that respectively control said power adjustment devices in accordance with the monitor result of said optical spectrum monitor sections, so that the average power of the optical signals belonging to said respective wavelength groups are approximately the same.

9. A multi-directional optical branching apparatus according to claim 8,
wherein said power adjusting devices are variable optical attenuators.

10. A multi-directional optical branching apparatus according to claim 8,
wherein said power adjusting devices are optical amplifiers.

11. A multi-directional optical branching apparatus according to claim 8,
wherein said optical amplifiers are provided between the input side optical paths of said optical transmission paths, and the common ports of said optical multiplexing/demultiplexing devices connected with said input side optical paths.

12. A multi-directional optical branching apparatus according to claim 8,
wherein said optical amplifiers are provided between the output side optical paths of said optical transmission paths, and the common ports of said optical multiplexing/demultiplexing devices connected with said output side optical paths.

13. A multi-directional optical branching apparatus according to claim 1, further comprising:
N optical amplifiers provided between the input side optical paths of said optical transmission paths, and the common ports of said optical multiplexing/demultiplexing devices connected with said input side optical paths;
optical power monitor sections that respectively monitor the total power of the wavelength division multiplexed signal lights output from said optical amplifiers; and
control sections that respectively control driving states of said optical amplifiers so that the total power of the wavelength division multiplexed signal lights monitored by said optical power monitor sections becomes constant at a predetermined level common to respective directions.

14. A multi-directional optical branching apparatus according to claim 13,
wherein optical amplifiers are provided between the output side optical paths of said optical transmission paths, and the common ports of said optical multiplexing/demultiplexing devices connected with said output side optical paths.

15. A wavelength division multiplexing optical transmission systems,
wherein the multidirectional optical branching apparatus in claim 13 is used for an optical branching node.
